(19) United States
(12) Patent Application Publication
(10) Pub. No.: US 2013/0262417 A1
(43) Pub. Date: Oct. 3, 2013

(54) Graphical Representation and Automatic Generation of Iteration Rule

(71) Applicants: Xiaofan Zhou, Cupertino, CA (US); Wu Cao, Redwood City, CA (US); Freda Xu, Cupertino, CA (US); Andrey Belyy, Sunnyvale, CA (US)

(72) Inventors: Xiaofan Zhou, Cupertino, CA (US); Wu Cao, Redwood City, CA (US); Freda Xu, Cupertino, CA (US); Andrey Belyy, Sunnyvale, CA (US)

(73) Assignees: Business Objects Software Ltd.; SAP AG, Walldorf (DE)

(21) Appl. No.: 13/437,170

(22) Filed: Apr. 2, 2012

(51) Int. Cl. G06F 17/30

(52) U.S. Cl. 707/694; 707/E17.001

(57) ABSTRACT

Embodiments relate to graphical representation and/or automatic generation of an iteration rule in mapping design that is to integrate or transform one or more input data sets into another target data set. The input and output data set can be of flat or hierarchical in nature. In an embodiment, a graphical interface allows users to specify an iteration rule (e.g. JOIN operation in a relational database) in a tree-like structure (e.g. a JOIN tree). The interface allows users to visualize and implement complicated and powerful combinations of multiple data sets, including data sets exhibiting hierarchical structure. Drag-and-drop techniques may be employed to reduce the need for manual typing. Also disclosed are procedures automatically generating an iteration rule based on the data mapping information, thereby reducing a need for manual mapping.

### BACKGROUND

In the field of data services, users frequently modify or combine one or more data sources using certain criteria, and produce a resulting target data set. In this process, each item in the target data set is usually computed using one item from each of the data sources. As used herein, an operation modifying or combining multiple data sources utilizing specific criteria and establishing the relationship between the items in the target data set and the ones in the data sources, is generally referred to as an iteration rule.

Embodiments relate to computing, and in particular, to a systems and methods for graphical representation and/or automatic generation of an iteration rule in mapping design, for example as may be employed in data integration and data transformation among disparate database systems, or message exchanges among heterogeneous application systems.

Unless otherwise indicated herein, the approaches described in this section are not prior art to the claims in this application and are not admitted to be prior art by inclusion in this section.

Within the specific context of a relational data model, one operation performed according to an iteration rule is referred to as a JOIN. The JOIN operation allows users to combine data from multiple data sets.

However, the use of JOIN operations for more than two input sets (also referred to herein as “multi-way JOINS”), may be impeded by lack of a user-friendly interface for specifying JOIN operation(s). This issue may be exacerbated where JOIN operations are to be performed on information that is stored in a hierarchical manner.

Accordingly, the present disclosure addresses these and other issues with embodiments of systems and methods allowing graphical representation of an iteration rule and its automatic generation in a mapping design user interface.

### SUMMARY

Embodiments relate to graphical representation and/or automatic generation of an iteration rule in a mapping design interface. In an embodiment, a graphical interface allows users to specify an iteration rule (e.g. JOIN operation in a relational database) in a tree-like structure (e.g. a JOIN tree). The interface allows users to visualize and implement complicated and powerful combinations of multiple data sets, including data sets exhibiting hierarchical structure. Drag-and-drop techniques may be employed to reduce the need for manual typing. Also disclosed are procedures for automatically generating an iteration rule based on the data mapping information, thereby reducing a need for manual mapping.

An embodiment of a computer-implemented method comprises providing a transform of at least one input data set to generate at least one target data set comprising a repeatable target node. An iteration rule for the repeatable target node is displayed as a tree-like structure graphically representing how data of the at least one input data set is joined to produce the target data set, wherein leaf nodes of the tree-like structure represent the at least one input data set, and parent nodes of the tree-like structure represent JOIN operations to be performed on the at least one input data set.

An embodiment of a computer system comprises one or more processors and a software program a software program, executable on said computer system. The software program is configured to provide a transform of at least one input data set to generate at least one target data set comprising a repeatable target node. The software program is further configured to display an iteration rule for the repeatable target node as a tree-like structure graphically representing how data of the at least one input data set is joined to produce the target data set, wherein leaf nodes of the tree-like structure represent the at least one input data set, and parent nodes of the tree-like structure represent JOIN operations to be performed on the at least one input data set.

An embodiment of a non-transitory computer readable storage medium embodies a computer program for performing a method. The method comprises providing a transform of at least one input data set to generate at least one target data set comprising a repeatable target node, and displaying an iteration rule for the repeatable target node as a tree-like structure graphically representing how data of the at least one input data set is joined to produce the target data set, wherein leaf nodes of the tree-like structure represent the at least one input data set, and parent nodes of the tree-like structure represent JOIN operations to be performed on the at least one input data set.

In certain embodiments, one of the JOIN operations comprises an INNER JOIN, a LEFT OUTER JOIN, a CROSS JOIN, or a PARALLEL JOIN.

According to some embodiments, the CROSS JOIN operation and the PARALLEL JOIN operation can have more than two input data sets.

In particular embodiments a result of one of the JOIN operations is input to another of the JOIN operations.

Some embodiments may further comprise automatically generating the iteration rule by performing an analysis of a mapping between the at least one input data set and the target data set.

In certain embodiments, the at least one input data set has a hierarchical structure.

The following detailed description and accompanying drawings provide a better understanding of the nature of various embodiments.

### BRIEF DESCRIPTION OF THE DRAWINGS

FIG. 1 is a generic representation showing a data transform creating a target data set from an input data set utilizing iteration rules.

FIG. 2 is graphical representation of one example of an iteration rule.

FIG. 3 is a graphical representation of another example of an iteration rule.

FIG. 4A is a simplified flow chart showing generation of an iteration rule according to an embodiment.

FIGS. 4B1-2 illustrates a specific example of generation of an iteration rule according to an embodiment.

FIG. 5 illustrates hardware of a special purpose computing machine which may be configured to produce a graphical representation of an iteration rule in accordance with particular embodiments.

FIG. 6 is an example of a computer system.

### DETAILED DESCRIPTION

The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, examples and specific details are set forth in order to provide a thorough understanding of various embodiments of the present invention. It will be evident, however, to one skilled in the art that embodiments as defined by the claims may include some or all of the features in these examples alone or in combination with other features described below, and may further include modifications and equivalents of the features and concepts described herein.

In a typical data integration and transformation task, users take one or more source data sets and produce a corresponding target data set. The source and target data sets can be in the form of database tables, flat files, or a document such as XML or IDOC etc.

In such data integration and transformation processes, users generally handle repeating structures (data sets). For example, a database table may comprise many rows representing a repeating construct. In another example, an XML document may comprise repeatable elements which can be viewed as data sets.

When two or more data sets exist in the inputs, a user specifies how these data sets are to be “joined” in order to properly produce the target result. A join is a way for combining data members from two or more data sets.

When the input data sets are joined, a new data set is created. As used herein, the term “iteration rule” refers to the manner in which a logical data set is created through join operations among the input data sets. Also, when there exists only one input data set, an iteration rule can still be specified to indicate how the logical data set is created by iterating through that input data set.

A final target data set may be created by iterating though this new logical data set, and applying further mapping rules. Examples of this phase may be performed by calling functions.

In order to allow visualization and expression of mapping logic from input data sets to reach the target data set according to certain embodiments, a graphical designer may be used. Such a graphical designer may allow a user to perform the following functions:

specify the mapping between one or more columns of input data sets, to a target column of an output data set;

establish conditions that certain columns from the data items (records) in the input data sets are to satisfy (e.g. a WHERE clause);

indicate order(s) in which data items (records) of the input data sets are to be processed or data items of the target data set to be arranged.

specify the uniqueness of certain columns in the input or output data sets to be enforced.

Embodiments may provide the capability to express the iteration rule in a graphical manner. That is, embodiments may depict how input data sets are to be joined, particularly in situations where more than two input data sets (or repeating structures) are involved (i.e. multi-way joins).

Particular embodiments relate to a tree-like graphic interface to specify an iteration rule. The interface allows users to specify arbitrarily complicated joins of flat data sets, as well as hierarchical repeatable structures. The tree-like structure may graphically represent how data of input data set(s) may be joined to produce the target data set, wherein leaf nodes of the tree-like structure represent the input data, and parent nodes of the tree-like structure represent JOIN operations to be performed on the input data.

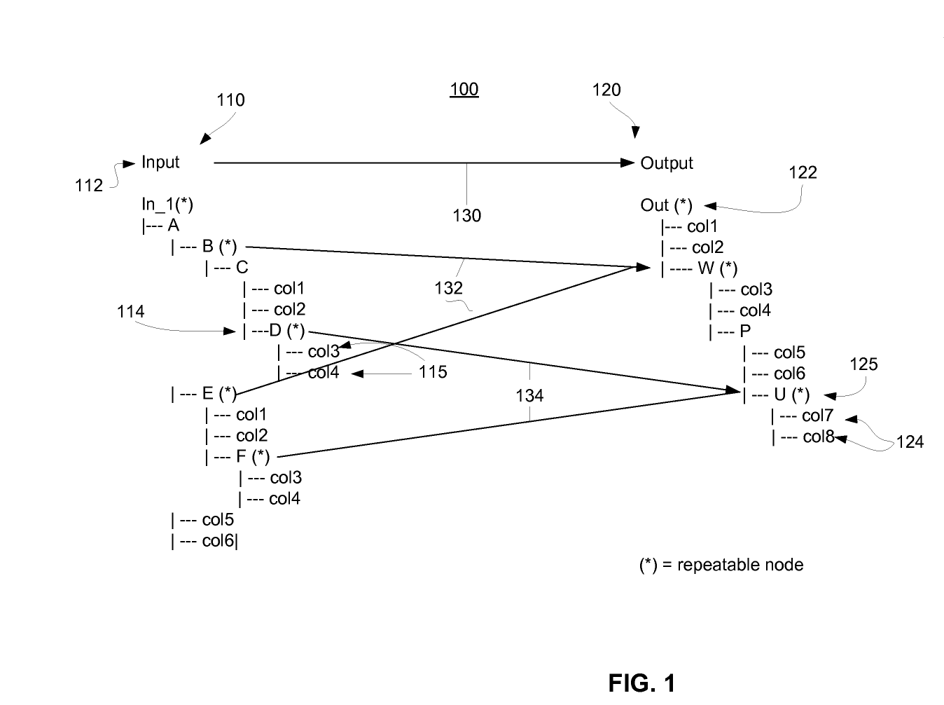

FIG. 1 shows a highly simplified representation of a data transform 100 creating an output (target) data set 120 from an input (source) data set 110. The input data set 110 includes a root node 112, as well as various other nodes including leaf nodes 115 and non-leaf nodes 114. Certain nodes are repeatable, as indicated in FIG. 1 with an asterix (*).

The output data set 120 also includes a root node 122, as well as various other nodes including leaf nodes 124 and non-leaf nodes 125. Certain of these nodes are also repeatable, again indicated in FIG. 1 by an (*).

A data transform utilizes an iteration rule to generate a repeatable node in the output data set. Thus in the particular example of FIG. 1, three iteration rules are shown. Iteration rule 130 generates the repeatable node “Out” from the repeatable node “In_1” of the input data set. Iteration rule 132 generates the repeatable node “W” from the repeatable nodes “B” and “E”. Iteration rule 134 generates the repeatable node “U” from the repeatable nodes “D” and “F”.

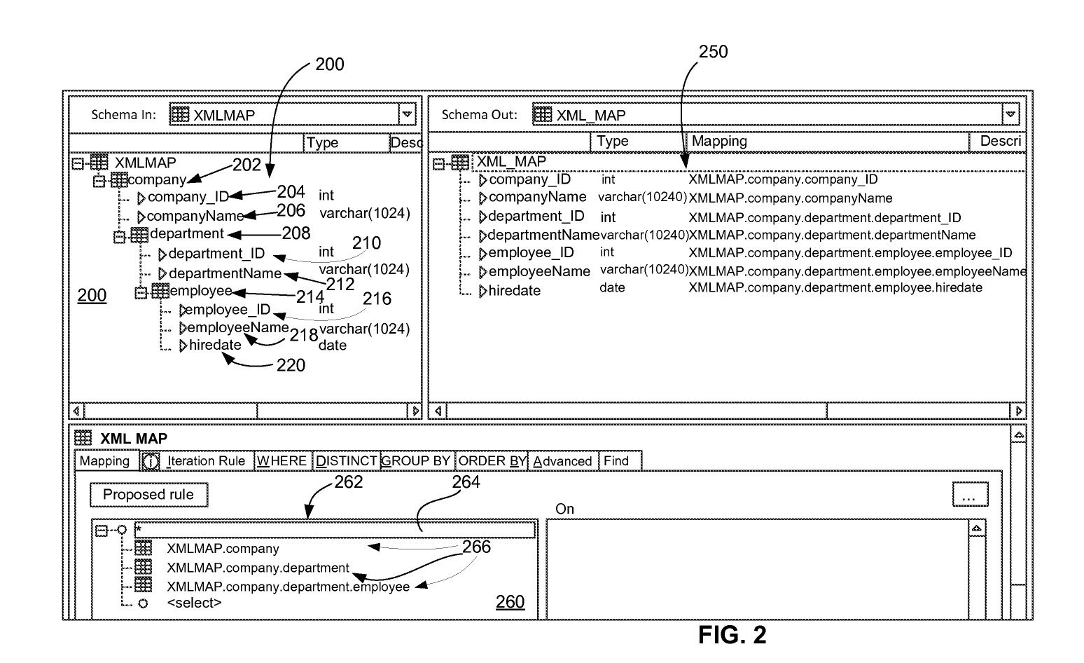

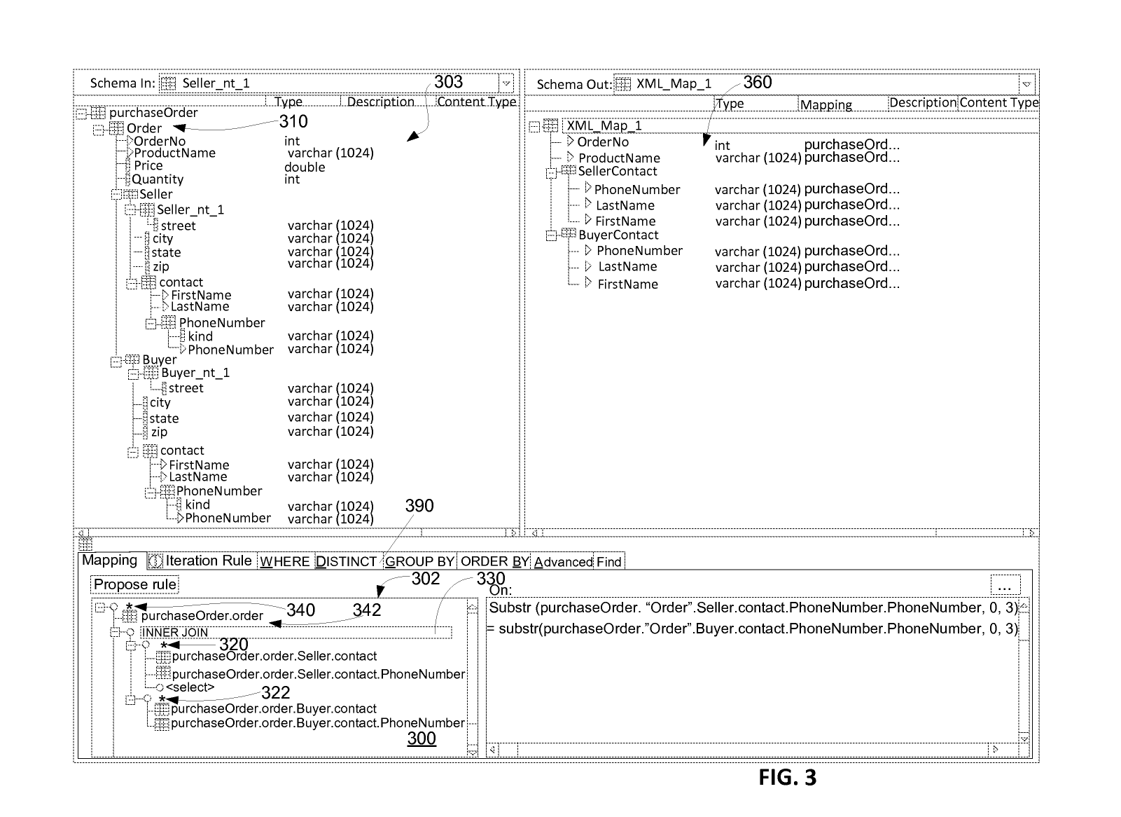

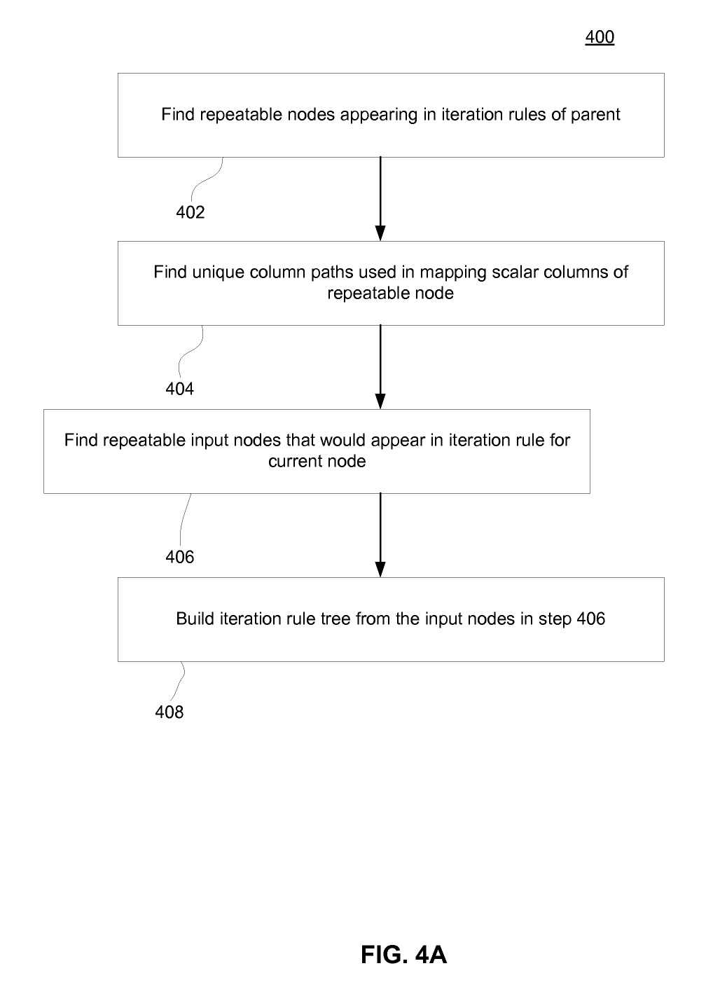

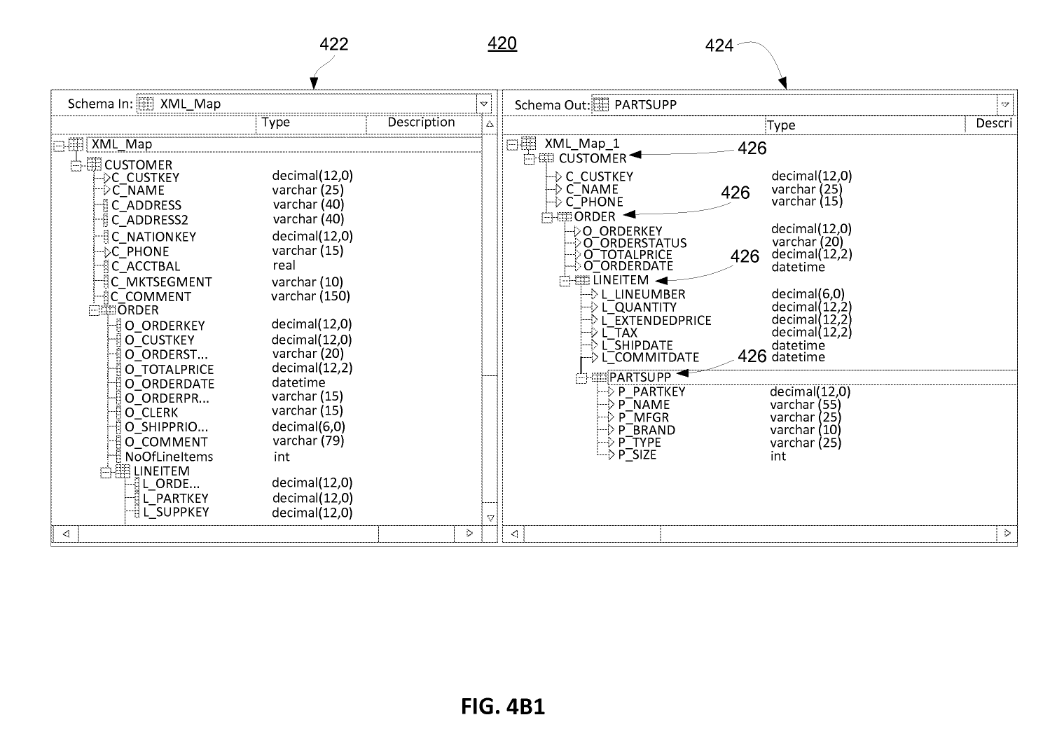

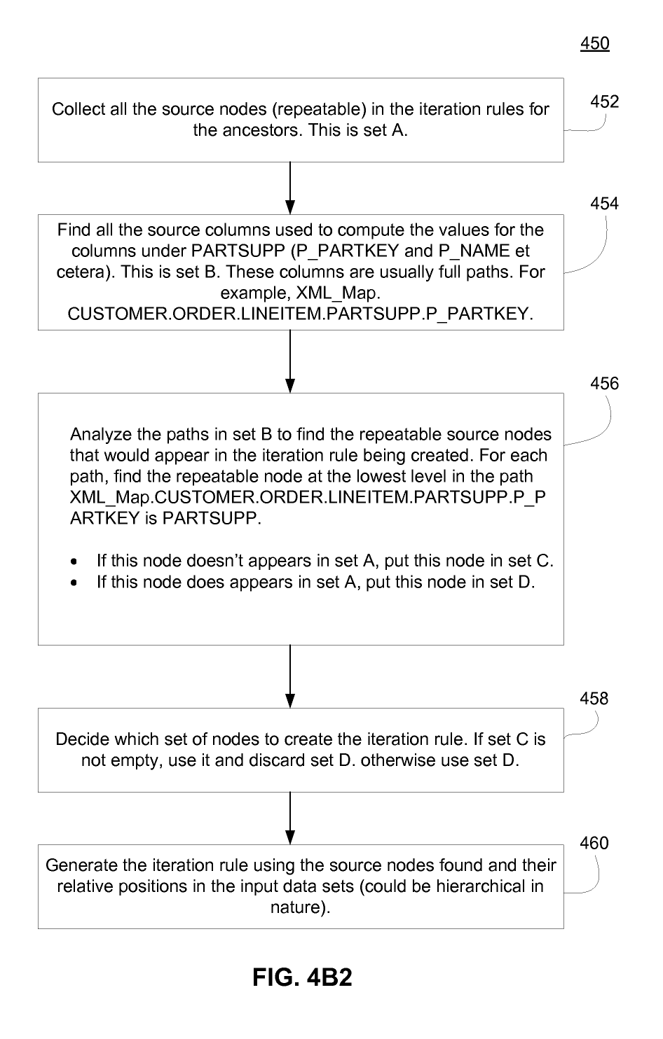

According to embodiments, an iteration rule can be graphically represented (e.g. as a tree-like structure), and can be automatically generated. The examples of FIGS. 2-3 discussed further below describe the graphical representation of iteration rules. The example of FIGS. 4B1-B2 discussed further below describes automatic generation of iteration rules.

While the particular embodiment of FIG. 1 shows a transform involving a single input data set, this is not required. Embodiments are also applicable to iteration rules utilized by transforms involving multiple input data sets.

And while the particular embodiment of FIG. 1 shows both the input data set and the output data set as hierarchical in nature including parent and child nodes, this is also not required. Iteration rules may be employed in transforms involving input data sets and output data sets exhibiting a hierarchical or non-hierarchical (flat) structure.

Embodiments employing iteration rules depicted in a graphical manner (e.g. a tree-like structure) may improve the expressive power of the mapping tools, especially for the hierarchical data. This is because in a hierarchical data structure, often there is more than one repeatable substructure (sub data set). Accordingly, an iteration rule may be used for each of these repeatable structures to indicate where the data sources are from, and how to join those data sources.

Embodiments of interfaces may exhibit one or more of the following general characteristics. For example, different kinds of joins may be treated as an operator, and may appear in the tree structure as non-leaf nodes.

According to various embodiments, the input data sets may be treated as operands. The input data sets and these repeatable structures (nodes) may appear in the tree structure as leaf nodes, and so are usually child nodes of an operator (JOIN) node.

In some embodiments, a JOIN operator can appear as a child node of another join operator. Thus the result set of the JOIN operator may be treated as the operand of the parent operator.

According to particular embodiments, depending on the types of JOIN being used, an operator node can have an ON condition, which enforces certain conditions among columns from the input data sets being met, just like a where clause.

In certain embodiments, the simplest tree structure may contain only a single node. In such cases, the node is an input data set.

For data stored in a hierarchical manner, a repeatable structure (e.g. node or element) may be modeled as a data set (e.g. table) in which a data member (e.g. record) is an instance that is usually hierarchical. Accordingly, to refer a data set as the operand or a column in the ON condition, the fully qualified path may be used.

At least three different kinds of join operations are possible. Various embodiments of the graphic interface may select the particular join operations that are supported.

For example, particular embodiments may be configured to interact with the XML_Map™ transform, a general purpose graphic designer available from SAP AG. Certain such embodiments may support the following join operations: INNER JOIN, LEFT OUT JOIN, and CROSS JOIN.

Moreover, certain embodiments may support a PARALLEL JOIN operation (which is not a Standard SQL join). Such a PARALLEL JOIN operation is useful in visualizing and transforming a hierarchical data model, when data from different branches or different documents are used in the same mapping.

A PARALLEL JOIN may operate in the following manner. Given two or more input data sets, one data member (e.g. record) is taken from each input data set in natural order, and one data member (i.e. record) is created in the logical data set.

Thus, using the first data member (e.g. record) in each of the input data set, the first data member (e.g. record) in the logical data set is created. Using the second data member (e.g. record) in each of the input data set, the second data member (e.g. record) in the logical data set is created. This process is repeated to create additional records in the logical data set.

As a result, a number of data members (e.g. records) in the result logical data set, is equal to the largest number of data members from the input data sets.

Particular embodiments may impose one or more limits on the graphical interface of an iteration rule. For example, an INNER JOIN and/or LEFT OUTER JOIN may have two child nodes (operands), but may have an ON condition (specified in a separate box).

In certain embodiments, the CROSS JOIN and the PARALLEL JOIN can have more than two child nodes (operands). In the specific XML_Map™ transform, an ON condition on these two joins may not be allowed due to the existence of a separate interface to specify a where clause.

However, this is for simplicity. For a complicated iteration rule, it may be useful to specify an ON condition at the individual operator level, and this limitation can be released.

In another aspect of particular embodiments, repeating structures in a parent-child relationship in hierarchical data, can be operated on using the CROSS JOIN, which dictates the processing engine to iterate through each instance of the parent node (data set), and for each instance of the parent data set, iterate through each instance of the child node (another data sets).

If needed, in certain embodiments the graphical interface can also be enhanced to handle the concept of “iteration range”. This is analogous to the “node range” concept of the XPath standard. For example, when there are multiple items in a data set, we can instruct the iteration to start from the first item in the data set and end at the 100^{th} item.

### EXAMPLES

Presented now are two particular examples illustrating graphical representation of an iteration rule according to various embodiments. A first example shows creation of an employee list in a flat data structure. FIG. 2 shows a graphical representation of this iteration rule.

In this example a hierarchical input data set (“XMLMap”) 200 includes a list 202 of companies. Each company includes a company_ID field 204, and a companyName field 206.

Moreover for each company in company list 202 there is a list 208 of departments. Each department includes a department_ID field 210, and a departmentName field 212.

Moreover, for each department in the department list 208, there is a list 214 of employees. This employee list 214 in turn includes employee_ID field 216, employeeName field 218, and hiredate field 220.

From this input data set 200, it is desired to create an output data set (“XML_Map”) 250 comprising a list of employees. For this purpose, an iteration rule 260 is created to look through the companies, departments and employees data.

This iteration rule 260 utilizes the CROSS JOIN operation—which is denoted in the user interface of FIG. 2 with an asterix (*) character. The iteration rule is graphically depicted as a tree-like structure 262 comprising one parent node 264 as the CROSS JOIN operation.

This CROSS JOIN has three child nodes 266, which are the three repeating nodes in the input data set:

XMLMap.company
XMLMap.company.department
XMLMap.company.department.employee

As a result of application of this iteration rule 260 to the input data set 200, the resulting output set 250 comprises a flat (non-hierarchical) listing of all employees from all the companies.

FIG. 3 shows a more complex example of graphical representation of an iteration rule 300, here involving identifying purchase orders having at least one pair of seller/buyer contacts whose contact phone numbers share the same area code. In this example, the input data set 303 comprises a list 304 of purchase orders stored in a hierarchical structure.

In each purchase order of list 310 there is a seller party 312 and a buyer party 314, each of which might have multiple contact persons 316. And, every contact person might have multiple phone numbers 318. It is desired to perform operation(s) expressed as an iteration rule and depicted in graphical form that identifies pairs of seller/buyer contacts sharing the same area code of their phone number.

Accordingly, the iteration rule depicted in the tree-like structure 302 first performs a CROSS JOIN 320 (indicated again with an *) of two repeating data sets for the seller party:

purchaseOrdersNew.“Order”.Seller.contact
purchaseOrdersNew.“Order”.Seller.contact.PhoneNumber

Similarly, the iteration rule performs a CROSS JOIN 322 (indicated again with an asterix) of two repeating data sets for the buyer party:

purchaseOrdersNew.“Order”.Buyer.contact
purchaseOrdersNew.“Order”.Buyer.contact.PhoneNumber

These two CROSS JOINs 320, 322 essentially create two lists of contact phone numbers: one for the Seller party, and another for the Buyer party. These lists in turn serve as child nodes input to a parent input node that performs another operation.

In particular, the iteration rule then performs an INNER JOIN 330 operation of the two result sets from the CROSS JOINs operations just described. The ON condition for this INNER JOIN checks to see if the area code of the Seller's phone number is the same as that of the Buyer's. Users specify the ON condition in the white box on the right of the iteration rule opened up when you click and highlight the INNER_JOIN operation 330.

The iteration rule then does a CROSS JOIN (*) operation 340 again, this time between the repeating parent data set “Order” 342 and the result set of the INNER JOIN 330. The result of application of the iteration rule is a target data set 360 comprising phone number pairs from Seller and Buyer contacts having a same area code.

It is noted that the result set of the INNER JOIN will create pairs of phone numbers for the Seller and Buyer contacts sharing the same area code for a single purchase order. Thus, the same Seller contact and Buyer contact might appear repeatedly in the list. For example, the Seller contact cell phone might share the same area code with both the Buyer's cell phone number and home phone number.

If a unique list of Seller and Buyer contact persons sharing at least one area code of their phone numbers is desired, a DISTINCT (per tab 390) may be performed on the following target columns.

### XML_Map_{—}1.OrderNo

### XML_Map_{—}1.SellerContact.LastName

XML_Map_{—}1.SellerContact.firstName

### XML_Map_{—}1.BuyerContact.LastName

XML_Map_{—}1.BuyerContact.firstName

According to certain embodiments, an iteration rule may not only be depicted graphically, but may also be manipulated and/or generated automatically utilizing the graphical depiction. Specifically, when multiple data sets (e.g. repeating structures) particularly hierarchical data sets are involved in an iteration rule, it may be desirable to have a way to generate the iteration rule automatically. This can not only help users visualize and understand the underlying data model, but also improve mapping design by reducing manual mapping.

The following aspects relate to automatic generation of iteration rules according to certain embodiments. In certain embodiments, automatic generation of iteration rules may be based upon column mappings between input data sets and target data sets. Analysis of the mappings allows the involved input data sets (repeating structures) to be identified, and allows the relationships between those data sets to be checked.

In particular embodiments, users are not required to map all the columns in the target data set before an iteration rule can be generated. Rather, in some cases as soon as one target column is mapped, the iteration rule can be properly generated.

When the output target data structure is hierarchical, two repeating nodes may have a parent-child relationship. In such a case, the iteration rule associated with the child repeating node is generated under the scope of the iteration rule associated with the parent repeating node. That is, the input data sets for the child repeating node are often child data sets of those input data sets in the parent repeating node.

Automatic generation of iteration rules according to certain embodiments may serve to provide insight to the user. The user is then free to manually confirm, reject, or modify an iteration rule that has been automatically generated.

For example, the ON condition may not be known and cannot be automatically generated. It may also not be known whether to use an INNER join or an OUTER join, with this decision being left to a user. Thus, automatic iteration rule generation may be accompanied by a request for user input confirming whether the generated iteration rule is desired, allowing the iteration rule to be modified accordingly if appropriate.

One embodiment of a procedure to automatically generate an iteration rule, is now described. This embodiment employs certain general assumptions and considerations.

For example, in this embodiment an iteration rule can only be generated based on the column mapping information. Accordingly, the column mapping is performed first so that at least one target column is mapped before the iteration rule can be generated.

In this embodiment, an iteration rule can also be manually created. In addition, the iteration rule can be created from scratch, or can be the result of modifying an existing iteration rule. Drag-and-drop techniques of a graphical representation of an iteration rule may be employed to reduce a need for manual typing.

According to this particular embodiment, an iteration rule can only be associated with a repeatable target node, as in this embodiment, a repeatable node is modeled as a data sets with more than one items, and the iteration rule dictates what data items in the input data sets are used to create each item in this target data set. A non repeatable node in the target structure is considered part of an item (instance) in the first repeatable node found in the path from this node to the root of the structure.

In this embodiment, an iteration rule can only be created with one or more repeatable input nodes. A non repeatable node in a source structure is considered part of an item in the first repeatable node found in the path from this node to the root of the source structure.

In this embodiment, when there are several repeatable nodes in a target path, the iterations are created in the order of parent to child. That is, the iteration rule is created for a parent repeatable node first.

According to this particular embodiment, a root node in the input data sets, whether flat (tables, flat files, and EXCEL™, etc.) or hierarchical, is always considered repeatable.

An iteration rule for a given repeatable target node in the target structure may be automatically generated as follows.

First, the repeatable input nodes appearing in the iteration rules of the parent nodes of the given target node, are found. Specifically, the iteration rules associated with the ancestor target nodes are analyzed. The input nodes (which must be repeatable) appearing in the iteration rules are collected. This set of input nodes may be referenced herein as A. This step must be used because input nodes in the iteration rule being created, are usually (but not always) the descendants of those repeatable input nodes in the iteration rules of the parent.

A next step is to find unique input column paths used in the mapping of the scalar columns in the instance of this repeatable target node. The column mapping expressions (including the where clause, ON condition, order by clause, and group by clause) under the current repeatable target node and the non-repeatable target nodes (recursively) under the current repeatable target node, are analyzed. This is to collect input column paths used to create instances of this repeatable target node. As a result, a set B of unique input column paths is created.

A next step is to find repeatable input nodes that would appear in the iteration rule that is being created. In this example, this set is referred to as C.

This can be done as follows. For each path in set B, starting from the lowest level, check each node in the path to see if it is repeatable. If it is repeatable, then check the following.

(1) If the node is not present in the set A (input nodes appearing in the iteration rules of the parent nodes), this node must appear in the new iteration rule, and is placed in set C.
(2) If the node is present in the set A (it appears as one of the input nodes of the iteration rule of the parent), stop and put the node into another set D.

As a result of the above, the mappings have been analyzed, and a set of repeatable input nodes (set C) that must appear in the iteration rule has been found. Also found is a set of repeatable input nodes (set D) that may or may not appear in the iteration rule.

Whether or not the input nodes present in set D should be in set C, is decided once all of the available mappings have been analyzed. The following describes one embodiment of a rule to decide whether or not to use the input nodes in set D:

if set C is empty, all the input nodes in set D are used to create the iteration rule (that is, all nodes in set D are placed into the empty set C);

if set C is NOT empty, discard set D.

The result of the above is a set of repeatable input nodes (set C) that will appear in the iteration rule. A tree is built from these nodes that represent their hierarchy in the input data sets. All of the root nodes are siblings at the top level of this tree.

A process flow for the automatic iteration rule generation process described above, is summarized generally in the diagram of FIG. 4A. In a first step 402 of the process flow 400, repeatable nodes appearing in iteration rules of a parent are found. In a next step 404, unique source column paths used in mapping scalar columns in the instance of a repeatable node are found. In step 406 repeatable input node(s) that would appear in the iteration rule for the instant node, are found. In step 408, an iteration rule tree is built from the input nodes in the previous step 406.

Automatic generation of an iteration rule is now described in connection with the particular example of FIGS. 4B1-2. In particular FIG. 4B1 shows a simplified transformation 420 with one input data structure 422 (here of hierarchical structure) from which a target structure 424 is to be created.

In this example the target structure includes four repeatable nodes (substructures) 426: CUSTOMER, ORDER, LINEITEM and PARTSUPP. Each of these four nodes will need an iteration rule. Non-repeatable nodes are omitted for clarity of illustration, as there is no need for an iteration rule for such non-repeatable nodes.

To automatically generate the iteration rule for the node:

XML_Map_{—}1.CUSTOMER.ORDER.LINEITEM.PARTSUPP

the iteration rules have already been created/generated for its ancestors:

### XML_Map_{—}1. CUSTOMER

### XML_Map_{—}1. CUSTOMER.ORDER

### XML_Map_{—}1. CUSTOMER.ORDER.LINEITEM

FIG. 4B2 is a flow diagram showing the steps involved in a method 450 to automatically generate the iteration rules. Specifically, in a first step 452 source nodes (repeatable) in the iteration rules for the ancestors are collected. This is set A.

In a next step 454, source columns used to compute the values for the columns under PARTSUPP (P_PARTKEY and P_NAME etc.) are found. This is set B. These columns are usually full paths. For example:

XML_Map.CUSTOMER.ORDER.LINEITEM.PARTSUPP.P_PARTKEY.

In a next step 456, the paths in set B are analyzed to find the repeatable source nodes that would appear in the iteration rule being created. For each path the repeatable node is found at the lowest level, for example the repeatable node at the lowest level in the path:

XML_Map.CUSTOMER.ORDER.LINEITEM.PARTSUPP.P_PARTKEY is PARTSUPP.

If this node doesn't appears in set A, put this node in set C.

If this node does appears in set A, put this node in set D.

In a next step 458, the set of nodes to create the iteration rule is decided. If set C is NOT empty, use it and discard set D. Otherwise use set D.

In a step 460, the iteration rule is generated using the source nodes found, and their relative positions in the input data sets. That is, in this example the input data sets are hierarchical in nature.

The following are rules to generate the iteration rule according to an embodiment:

use CROSS JOIN for nodes having a parent-child relationship;

use PARALLEL JOIN as the default for sibling nodes inside the hierarchical structure;

use CROSS JOIN for root nodes—users can change the CROSS JOIN to INNER JOIN or OUTER JOIN with an ON condition.

As an example, if the end result of analysis produces a set of nodes organized according to the following hierarchy (as appeared in the original input structures, and omit the non repeatable nodes in the structures):

```
A
  |----B
      |---C
      |---D
E
  |--F
  |--G
```

The iteration rule that would be automatically generated is: if A or E or both are root nodes:

(* (* A A.B (∥A.B.C A.B.D)) (* E E.F E.F.G))

otherwise,

(∥(* A A.B (∥A.B.C A.B.D)) (* E E.F E.F.G))

The above expressions mimic grammars of the programming language Lisp. These expressions also naturally resemble their appearance in the graphical interface.

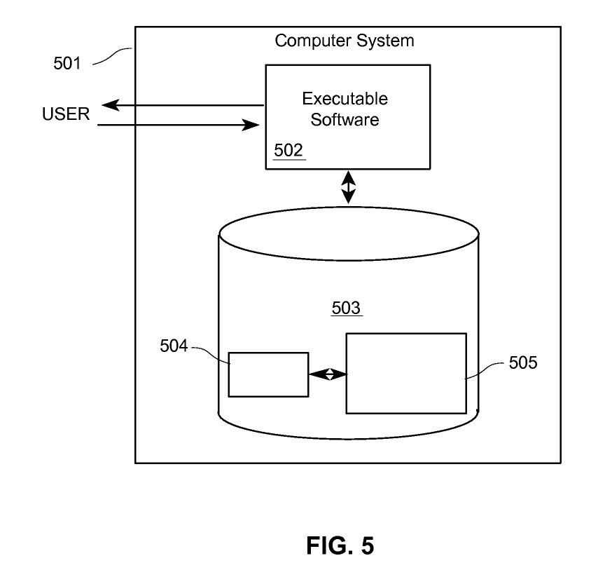

FIG. 5 illustrates hardware of a special purpose computing machine. This computing machine may be configured to produce graphical representation of iteration rules in accordance with particular embodiments.

In particular, computer system 500 comprises a processor 502 that is in electronic communication with a non-transitory computer-readable storage medium 503. This computer-readable storage medium has stored thereon code 505 corresponding to the view engine responsible for generating a graphical representation of an iteration rule (e.g. in a tree-like structure having parent nodes and leaf nodes). Code 504 corresponds to an engine responsible for automatically generating an iteration rule based upon an analysis of the input data set as has been described above. Code may be configured to reference data stored in a database of a non-transitory computer-readable storage medium, for example as may be located in a remote database server or a file system.

Embodiments of data transform services may be run in conjunction with a computer system which may comprise a software server. A number of software servers together may form a cluster, or logical network of computer systems programmed with software programs that communicate with each other and work together to process requests.

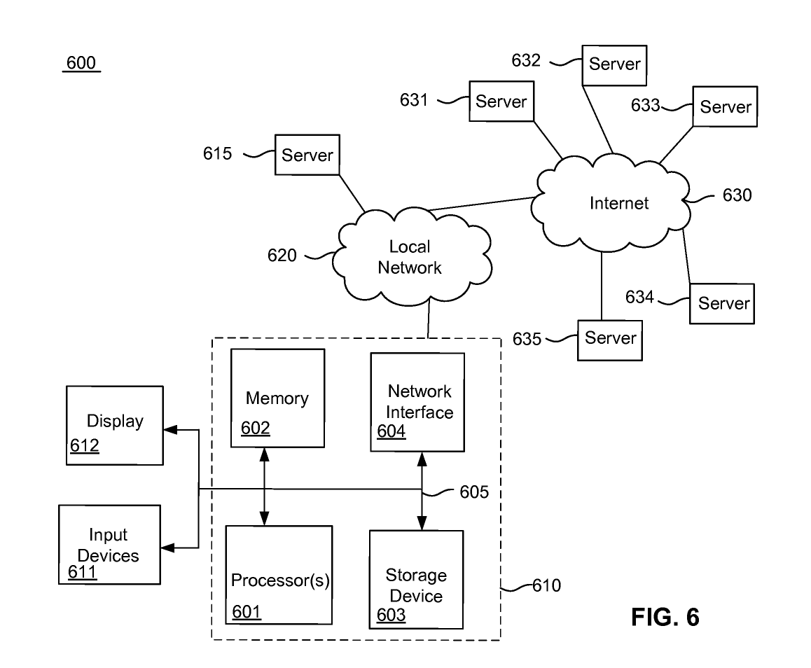

An example computer system 610 is illustrated in FIG. 6. Computer system 610 includes a bus 605 or other communication mechanism for communicating information, and a processor 601 coupled with bus 605 for processing information.

Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both.

A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read.

Storage device 603 may include source code, binary code, or software files for performing the techniques above, for example. Storage device and memory are both examples of computer readable media. The computer system generally described in FIG. 6 includes at least those attributes described in FIG. 5.

Computer system 610 may be coupled via bus 605 to a display 612, such as a cathode ray tube (CRT) or liquid crystal display (LCD), for displaying information to a computer user. An input device 611 such as a touch screen, is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be for Broadband Wireless Access (BWA) technologies. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an Intranet, or the Internet 630. For a local network, computer system 610 may communicate with a plurality of other computer machines, such as server 615. Accordingly, computer system 610 and server computer systems represented by server 615 may form a cloud computing network, which may be programmed with processes described herein.

In an example involving the Internet, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing a transform of at least one input data set to generate at least one target data set comprising a repeatable target node; and
displaying an iteration rule for the repeatable target node as a tree-like structure graphically representing how data of the at least one input data set is joined to produce the target data set, wherein leaf nodes of the tree-like structure represent the at least one input data set, and parent nodes of the tree-like structure represent JOIN operations to be performed on the at least one input data set.

2. The method of claim 1 wherein one of the JOIN operations comprises an INNER JOIN, a LEFT OUTER JOIN, a CROSS JOIN, or a PARALLEL JOIN.

3. The method of claim 2 wherein the CROSS JOIN operation and the PARALLEL JOIN operation have more than one input data set.

4. The method of claim 1 wherein a result of one of the JOIN operations is input to another of the JOIN operations.

5. The method of claim 1 further comprising:
automatically generating the iteration rule by performing an analysis of a mapping between the at least one input data set and the target data set.

6. The method of claim 1 wherein the at least one input data set has a hierarchical structure.

7. A non-transitory computer readable storage medium embodying a computer program for performing a method, said method comprising:
providing a transform of at least one input data set to generate at least one target data set comprising a repeatable target node; and
displaying an iteration rule for the repeatable target node as a tree-like structure graphically representing how data of the at least one input data set is joined to produce the target data set, wherein leaf nodes of the tree-like structure represent the at least one input data set, and parent nodes of the tree-like structure represent JOIN operations to be performed on the at least one input data set.

8. The non-transitory computer readable storage medium of claim 7 wherein one of the JOIN operations comprises an INNER JOIN, a LEFT OUTER JOIN, a CROSS JOIN, or a PARALLEL JOIN.

9. The non-transitory computer readable storage medium of claim 8 wherein the CROSS JOIN operation and the PARALLEL JOIN operation have more than one input data set.

10. The non-transitory computer readable storage medium of claim 7 wherein a result of one of the JOIN operations is input to another of the JOIN operations.

11. The non-transitory computer readable storage medium of claim 9 wherein the method further comprises:
automatically generating the iteration rule by performing an analysis of a mapping between the at least one input data set and the target data set.

12. The non-transitory computer readable storage medium of claim 7 wherein the at least one input data set has a hierarchical structure.

13. A computer system comprising:
one or more processors;
a software program, executable on said computer system, the software program configured to:
provide a transform of at least one input data set to generate at least one target data set comprising a repeatable target node; and
display an iteration rule for the repeatable target node as a tree-like structure graphically representing how data of the at least one input data set is joined to produce the target data set, wherein leaf nodes of the tree-like structure represent the at least one input data set, and parent nodes of the tree-like structure represent JOIN operations to be performed on the at least one input data set.

14. The computer system of claim 13 wherein one of the JOIN operations comprises an INNER JOIN, a LEFT OUTER JOIN, a CROSS JOIN, or a PARALLEL JOIN.

15. The computer system of claim 14 wherein the CROSS JOIN operation and the PARALLEL JOIN operation have more than one input data set.

16. The computer system of claim 13 wherein a result of one of the JOIN operations is the at least one input data set to another of the JOIN operations.

17. The computer system of claim 13 wherein the software program is further configured to:
automatically generate the iteration rule by performing an analysis of a mapping between the at least one input data set and the target data set.

18. The computer system of claim 13 wherein the at least one input data set has a hierarchical structure.
